(19) United States
(12) Patent Application Publication
(10) Pub. No.: US 2025/0349922 A1
(43) Pub. Date: Nov. 13, 2025

(54) IMPURITY MANAGEMENT PROCESS FOR LITHIUM-ION BATTERY RECYCLING

(71) Applicant: Ascend Elements, Inc., Westborough, MA (US)

(72) Inventors: Kee-Chan Kim, Belmont, MA (US); Bebel E. Villar Monteagudo, Worcester, MA (US); Eric Gratz, Stow, MA (US)

(21) Appl. No.: 18/661,475

(22) Filed: May 10, 2024

(51) Int. Cl. H01M 10/54; B09B 3/10; B09B 3/70; B09B 3/80; B09B 101/16; C22B 1/02; C22B 3/00; C22B 3/24; C22B 3/42; C22B 3/44; C22B 7/00; C22B 15/00; C22B 26/12; C22B 26/22; C22B 47/00

(52) U.S. Cl. CPC H01M 10/54; B09B 3/10; B09B 3/70; B09B 3/80; C22B 1/02; C22B 3/24; C22B 3/42; C22B 3/44; C22B 7/007; C22B 15/0006; C22B 15/0067; C22B 15/0089; C22B 19/22; C22B 23/0407; C22B 26/12; C22B 26/22; C22B 47/00; B09B 2101/16

(57) ABSTRACT

Methods are provided for removing impurities from recycled battery black mass. The method includes mixing a delithiated black mass with a first solution to form a pre-leached delithiated black mass and a pre-leach solution, separating the pre-leached delithiated black mass from the pre-leach solution, mixing the separated pre-leached delithiated black mass and a second aqueous solution to form a mixture comprising graphite and a leachate solution, and separating the graphite and the leachate solution. The pre-leach solution is comprised of a first group of impurity ions while the leachate solution is comprised of a second group of impurity ions and cathode metal ions.

### FIELD

The present description relates generally to methods for managing impurities present in a recycling stream derived from used lithium-ion batteries.

### BACKGROUND/SUMMARY

Many technologies, such as electric vehicles and cellphones to name a few, rely on lithium-ion batteries (LIBs). However, LIBs may degrade after a finite number charging/discharging cycles and thus become spent LIBs and demand replacement. Recycling of spent LIBs to recover metals such as lithium, nickel, cobalt, and/or manganese as battery grade materials is important to maintaining a critical and circular supply of metals for LIBs. Battery chemistry may vary depending on a source of LIB and may include elements in addition to the recovery metals of interest. For example, in addition to lithium, nickel, cobalt, and/or manganese, LIBs may include calcium, magnesium, iron, aluminum, copper, fluorine, and zinc.

Efficient recycling of LIBs may demand a method considering each impurity element and an order of removal during the recycling process. Impurities may be precipitated or otherwise removed from a leach solution together prior to removing the desired metals needed to form cathode active material precursors. Alternatively, sources of some impurities such as electrolyte and current collectors may be physically separated from the battery electrode materials before leaching occurs. However, the inventors recognize that removing the impurities in a single step may demand conditions which also result in premature loss of the metals of interest. Further, physically separating impurities decreases recycling throughput by adding extra steps before the leaching process.

In one example, the issues described above may be at least partially addressed by a method for removing impurities from recycled battery black mass, comprising: mixing a delithiated black mass and a first aqueous solution to form a pre-leached delithiated black mass and a pre-leach solution, the pre-leach solution comprising a first group of impurity ions from the delithiated black mass, separating the pre-leached delithiated black mass and the pre-leach solution, mixing the separated pre-leached delithiated black mass and a second aqueous solution to form a mixture comprising graphite and a leachate solution, the leachate solution comprising cathode precursor metal ions and a second group of impurity ions from the pre-leached delithiated black mass, and separating the graphite and the leachate solution. In this way, impurity ions can be separated from the cathode precursor metal ions and a pre-cathode active material salt may be precipitated from the solution having a purity level demanded for use in synthesizing new cathode active materials for lithium ion batteries.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 schematically shows ions separated into precipitate and solution during removal of impurities for recycled lithium ion batteries.

FIG. 2A shows a flowchart of an overview of a method of obtaining cathode active material precursors from spent lithium-ion batteries.

FIG. 2B shows a flowchart of an example of removing a second group of impurities from a leachate.

FIG. 3 schematically shows an exemplary embodiment of removing impurities in recycled battery material.

FIG. 4 shows a graph of fluoride concentration as a function of eluate volume for fluoride removal by activated alumina.

FIG. 5 shows a graph of fluoride concentration as a function of eluate volume for fluoride removal by ion exchange.

FIG. 6 shows a graph of copper concentration as a function of eluate volume for copper removal by ion exchange.

FIG. 7 shows a graph of zinc concentration as function of eluate volume for zinc removal by ion exchange.

### DETAILED DESCRIPTION

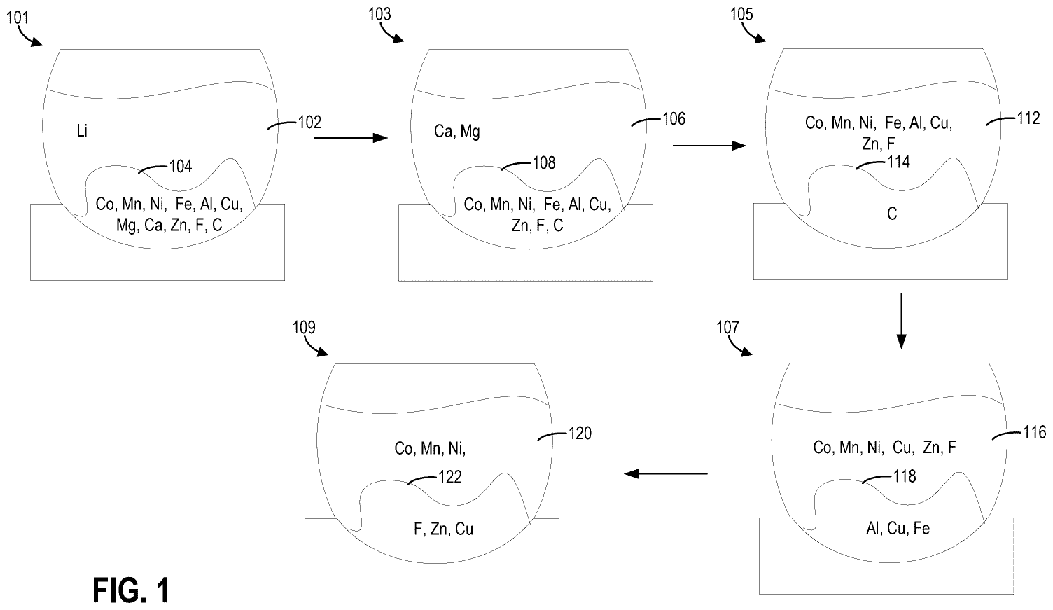

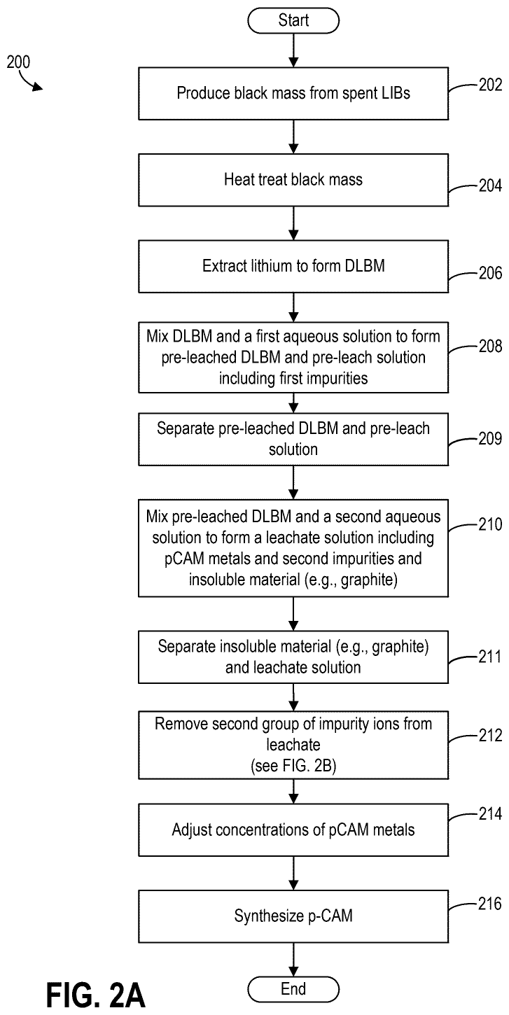

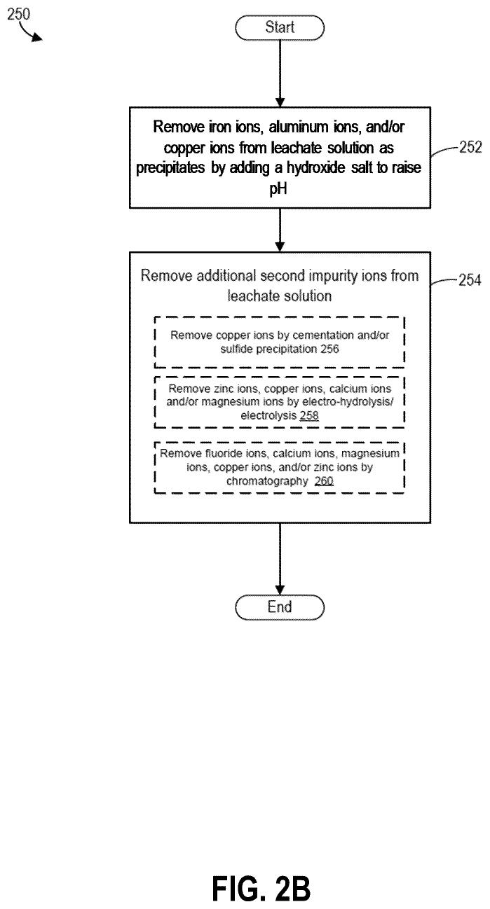

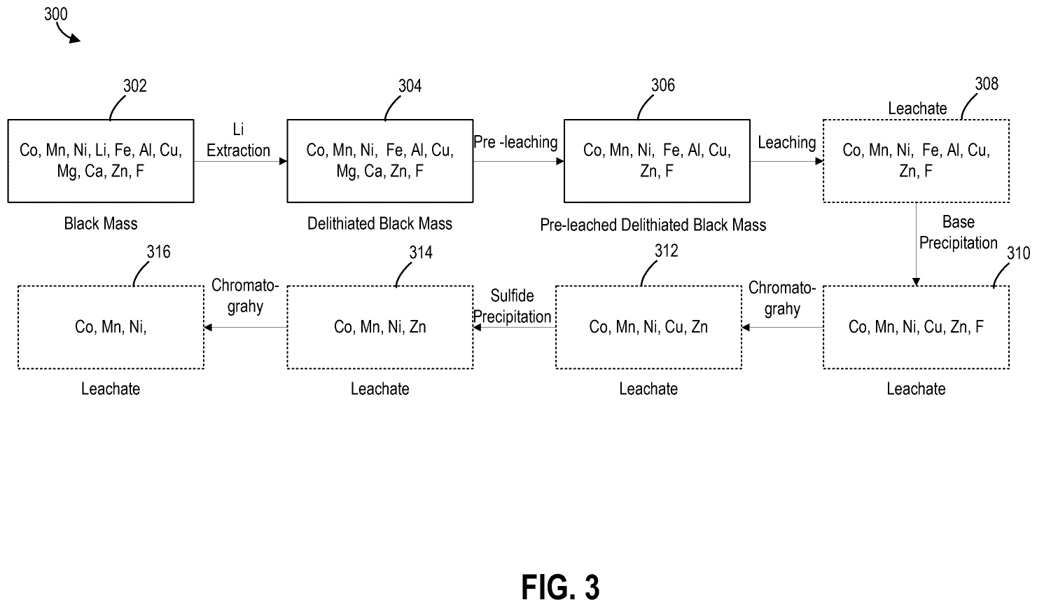

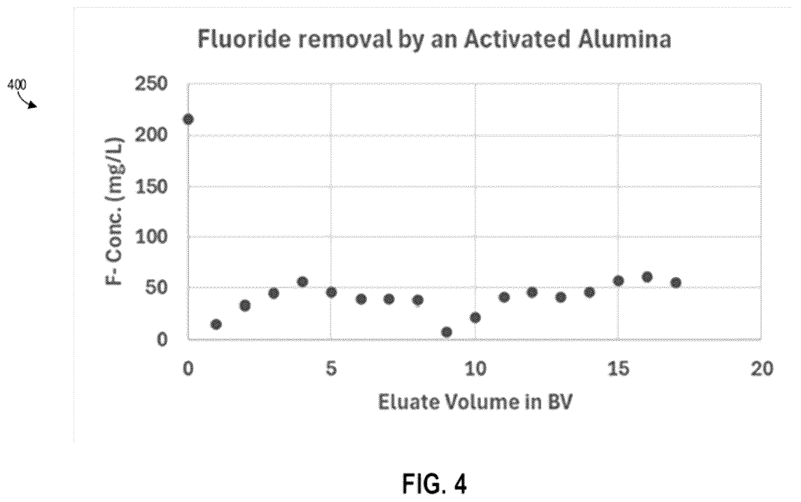

The following description relates to methods for impurity removal from a lithium-ion battery (LIB) recycling stream. The LIB recycling stream may take spent LIBs as input material and output a desired cathode active material precursor (p-CAM) such as co-precipitated hydroxides of nickel, manganese, and cobalt. Additionally, lithium salts may also be recovered to reuse in battery components. The method of partitioning groups of impurities from the spent LIB recycling stream between solid and liquid states is shown schematically in FIG. 1. An example of a method for producing p-CAM from spent LIBs is shown in FIG. 2A. A granular battery black mass may be formed from the spent LIBs, the granular battery black mass including the p-CAM metal ions as well as other impurities. The method may include multiple steps for removing impurities. In some examples, a first group of impurity ions may be solubilized and removed from the granular delithiated battery black mass while the p-CAM metal ions (e.g., cobalt, nickel, and manganese) remain with the granular delithiated battery black mass. Herein p-CAM metal ions are cathode precursor metal ions. After removal of the first group of impurities, the granular black mass may be leached to solubilize the p-CAM metal ions and a second group of impurity ions. Further purification steps may separate the second group of impurity ions from the leachate as shown in the flowchart of FIG. 2B. An exemplary embodiment of a process to remove impurities from the granular battery black mass is shown schematically in FIG. 3. In some examples, chromatography techniques including the use of ion exchange materials may be effective at removing some impurities from the leachate solution as demonstrated in the graphs shown in FIGS. 4-7.

Isolation of desirable p-CAM metal ions from impurity ions of recycled LIBs may include a series of steps wherein impurity ions are separated from p-CAM metal ions by chemical and/or physical processes which selectively move ions from being part of a solid phase to being part of a liquid phase and vice versa. Selectivity may be accomplished by different acid solubilities, salt solubilities, and/or adsorption to solid media. Impurity ions may be separated as groups by recognizing these chemical properties and leveraging easily scalable solid liquid separation steps. FIG. 1 schematically shows an exemplary embodiment of the ions moving between solid and liquid phases as part of a process for removing impurities from recycled battery mass.

In a first mixture, 101, aqueous extraction solution 102 may include lithium ions and a delithiated granular component 104 of the mixture may include p-CAM metal ions including nickel ions, manganese ions, and cobalt ions in addition to a first group of impurity ions including magnesium ions and calcium ions, a second group of impurity ions including iron ions, aluminum ions, copper ions, zinc ions, and fluoride ions, and insoluble materials such as elemental carbons (e.g., graphite). As one example, delithiated granular component 104 may be a delithiated black mass as described further below.

Aqueous extraction solution 102 and delithiated granular component 104 may be separated. Delithiated granular component 104 and a first aqueous solution may be combined to form second mixture 103. Second mixture 103 may include pre-leach solution 106 and pre-leached granular component 108. Pre-leach solution 106 may include the first group of impurity ions, including at least one of calcium ions and magnesium ions. The first group of impurity ions may be alkaline earth metal ions. Further, the first group of impurity ions may be acid (e.g., pH 3-6) soluble ions. Pre-leached granular component 108 may include the second group of impurity ions, including at least one of iron ions, copper ions, aluminum ions, zinc ions, fluoride ions. The pre-leached granular component 108 may further include insoluble materials as well as p-CAM metal ions including cobalt ions, manganese ions, and nickel ions. The second group of impurity ions may include transition metal ions and halide ions. Further, the second group of impurity ions may include low pH (e.g., pH<2) soluble ions.

Pre-leach solution 106 and pre-leached granular component 108 may be separated. Pre-leached solid component 108 and a second aqueous solution may be combined to form third mixture 105. Third mixture 105 may include leachate solution 112 and insoluble material 114. As one example, the insoluble material 114 may be graphite and the third mixture 105 may thus include leachate solution 112 and graphite. The leachate solution 112 may now include the p-CAM metals ions and the second group of impurity ions while insoluble material 114 remains in a solid phase.

Insoluble material 114 and leachate solution 112 may be separated. If the insoluble material is graphite, the leachate solution and the graphite may be separated. A hydroxide salt and leachate solution 112 may be combined to obtain fourth mixture 107. Fourth mixture 107 may include first precipitate solid component 118. First precipitate solid component 118 may include salts of aluminum ions, copper ions, and iron ions. As one example, first precipitate solid component 118 may be a hydroxide precipitate formed by adding hydroxide salts to leachate solution 112. Leachate solution 116 of fourth mixture 107 may still include p-CAM metal ions as well as zinc ion impurities, copper ion impurities, and fluoride ion impurities. Leachate solution 116 of fourth mixture 107 may be substantially depleted of aluminum ions, copper ions, and iron ions. Herein, substantially depleted may refer to 5% or less remaining.

First precipitate solid component 118 and leachate solution 116 may be separated. Leachate solution 116 may undergo further chemical and/or physical processes to form fifth mixture 109. Fifth mixture 109 may include p-CAM metal ion solution 120 and second solid impurity component 122. p-CAM metal ion solution 120 may include cobalt ions, manganese ions, and nickel ions. Second solid impurity component 122 may include fluoride ions, zinc ions, and copper ions. In some examples fifth mixture 109 may be a combination of mixtures formed during multiple chemical and/or physical processes. For example, second solid impurity component 122 may include chromatography resins or adsorbents on which fluoride, zinc, and/or copper ions have been adsorbed. As a further example, second solid impurity component 122 may additionally or alternatively include precipitants formed by cementation or addition of sulfide precipitant to the leachate. As a further example, second solid impurity component 122 may be additionally or alternatively include solids precipitated on an electrode during electro-hydrolysis.

p-CAM metal ion solution 120 and second solid impurity component 122 may be separated. A molar ratio of the p-CAM metal ions may be adjusted to a desired cathode active material ratio by adding additional p-CAM metal salts to p-CAM metal ion solution 120. p-CAM such as nickel cobalt manganese hydroxides may be precipitated from p-CAM metal ion solution 120 having a desired purity for use in new lithium ion batteries.

Turning now to FIG. 2A, a flowchart of a method 200 for recycling spent LIBs is shown. Method 200 may partition components of the spent LIB between liquid and solid phases by chemical and physical reactions as described above with respect to FIG. 1. The spent LIBs may include one or more lithium electroactive materials such as lithium nickel cobalt manganese oxide (NCM), lithium cobalt oxide (LCO), lithium nickel cobalt aluminum oxide (NCA), lithium iron phosphate (LFP), and the like.

At 202, method 200 includes procuring or producing a granular black mass, herein referred to as black mass, from the spent LIBs. In an exemplary embodiment, producing the black mass may be recycled battery black mass and may include first discharging the spent LIBs followed by shredding the spent LIBs into a powdered solid material. The black mass may include anode and cathode active materials, separator materials, current collectors, and electrolytes. In some examples, the anodes, cathodes, separators, current collectors, and electrolytes may not be separated from each other before shredding into the black mass. For this reason, the black mass may include the impurities from other components of the battery in addition to the cathode electroactive materials. In this way, the time, equipment, and reagents demanded for step 202 may be minimized because separation of the materials of the spent LIB is not demanded.

At 204, method 200 includes heat treating the black mass. Heat treating the black mass may include subjecting the black mass to carbothermal reduction. For example, the black mass may be heated at elevated temperatures in an atmosphere including oxygen and an inert gas for a duration. As one example, the elevated temperature may be greater than 550° C. Further, the elevated temperature may be in a range of 550° C. to 700° C. As one example, the duration of heat treatment may be greater than 15 minutes. In some examples, the duration of heat treatment may be in a range of 15 minutes up to 2 hours. In some examples, the heat treatment atmosphere may include less than or equal to 3% oxygen. In this way, lithium species in the black mass may be converted to lithium carbonate.

At 206, method 200 includes extracting lithium from the black mass to form delithiated black mass (DLBM). DLBM may be an example of delithiated granular component 104 described above with respect to FIG. 1. Extracting lithium may include mixing the heat-treated black mass and water for a duration. Lithium in the form of lithium carbonate may be sufficiently soluble in water that mixing the heat-treated black mass with water transfers substantially (e.g., within 5%) all of the lithium ions in the form of lithium carbonate into the aqueous phase, leaving the remaining metal ions and impurities in the granular DLBM. As a further example, no additional reagents such as oxidants, acids, bases, etc. may be added to the water for extracting lithium. Solid/liquid separation may be used to separate the DLBM and the lithium leached solution from which solid lithium carbonate can be recovered.

At 208, method 200 includes mixing the DLBM and a first aqueous solution to form a pre-leached DLBM and a pre-leach solution. The pre-leach solution includes a first group of impurity ions. The first group of impurity ions may include one or more of magnesium ions and calcium ions. The first aqueous solution may be an acidic aqueous solution. The pre-leached DLBM may remain in the solid phase, so that the mixture of pre-leached DLBM and pre-leach solution forms a slurry. The pre-leach solution may be an example of pre-leach solution 106 of FIG. 1 and the pre-leached DLBM may be an example of pre-leached granular component 108 of FIG. 1. As one example, a pH of the first aqueous solution may be in a range of 2.0 and 7.0. As a further example, the pH of the first aqueous solution may be in a range of 3.0 to 6.0. In additional examples, the pH of the first aqueous solution may be in a range of 4.0 to 5.0. In some examples the pH of the first aqueous solution may be 4. Additionally, mixing the DLBM and the first solution may include first mixing the DLBM with water and then gradually adding acid to decrease the pH to the pH of the first aqueous solution and further actively maintaining the pH of the first aqueous solution during mixing. For example, the pH of the slurry may be actively maintained by adding acid and/or base to correct for fluctuations in pH. In this way the pH of the first solution may be gradually decreased and then maintained at a desired level for pre-leaching.

Mixing the DLBM and the first aqueous solution may further include raising a temperature of a slurry of the DLBM and the first aqueous solution. In some examples, the temperature of the slurry of the DLBM and the first aqueous solution may be in a range of 20° C. to 90° C. In further examples, the temperature of the slurry of the DLBM and the first aqueous solution may be in a range of 50° to 90°. In additional examples, the temperature of the slurry of the DLBM and the first aqueous solution may be in a range of 80° to 90°. Additionally, mixing the DLBM and the first aqueous solution may occur for a duration in a range of 2 hours to 24 hours. In some examples, the duration may be in a range of 4 hours to 18 hours. In some examples, a duration of mixing may be increased if a temperature of the slurry is decreased and vice versa.

Table 1 below shows percent removal of elements of interest from DLBM before and after pre-leaching. Percent removal is determined by elemental analysis via inductively coupled plasma optical emission spectroscopy (ICP-OES) of dried DLBM before and after pre-leaching. A first example is shown wherein a pH of the first solution is 3.0 and a second example is shown wherein the pH of the first solution is 4.0.

TABLE 1
Percent removal of metals and impurities by pre-leaching

| | Leaching at | Leaching at |
|---|---|---|
| | pH = 3 | pH = 4 |
| | % Removal | % Removal |
| Ni | 4.8% | 6.3% |
| Mn | 66.7% | 80.1% |
| Co | 39.8% | 52.6% |
| Cu | 54.0% | 38.3% |
| Li | 56.4% | 64.2% |
| Ca | 69.3% | 90.1% |
| Mg | 45.1% | 61.0% |
| Zn | 46.2% | 28.3% |
| Si | 35.8% | 78.8% |

As shown in Table 1, pre-leaching may remove a first group of impurity ions from the DLBM. The first group of impurity ions may include magnesium ions, which are decreased by as much as 61% by pre-leaching and calcium ions which are decreased by as much as 90%. Additionally, pre-leaching may decrease an amount of other impurity ions including zinc ions, copper ions and silicon ions. Further, pre-leaching may remove less p-CAM metal ions than impurity ions, and may favorably remove more Mn ions than Ni ion and Co ion, which may be preferable to form a Ni ion enriched leach solution for a synthesis of high Ni cathode active precursor material. Specifically, nickel ions may be decreased by less than 10%. Further, a preferential pre-leaching process may remove nickel ions by less than 5%.

Method 200 proceeds to 209 and includes separating the pre-leached DLBM and the pre-leach solution. In this way, method 200 includes removing magnesium ions and calcium ions from the pre-leach solution. Separating may include separating by solid-liquid separation methods such as filtrations. Method 200 continues to 210 and includes mixing the pre-leached DLBM and a second aqueous solution to obtain a mixture of leachate solution and insoluble material. In one example, the insoluble material may be graphite and the mixture obtained at 210 includes graphite and leachate solution. The leachate solution may include the p-CAM metal ions and a second group of impurity ions, and the insoluble material may include graphite. The leachate solution may be an example of leachate solution 112 of FIG. 1 and the insoluble material may be an example of insoluble material (e.g., graphite) 114 of FIG. 1.

The second aqueous solution may be an acidic aqueous solution. The second aqueous solution may be more acidic than the first aqueous solution, and a pH of the second aqueous solution may be lower than a pH of the first aqueous solution. As one example, the second aqueous solution may have an acid concentration resulting in a leachate solution having a pH that is less than 2. As a further example, the acid concentration of the second aqueous solution may provide a leachate solution having a pH in a range of −0.5 up to 0.5. In some examples, the second aqueous solution may include a strong acid such as sulfuric acid or the like at a concentration in a concentration range of 1M up to 7M. In some examples, a temperature of the second aqueous solution may be in a range of 50° C. to 90° C. In some examples the mass to volume ratio of the pre-leached DLBM and the second aqueous solution may be in a range of 1:1 (DLBM (wt): second solution(vol)) up to 1:5.

In an exemplary embodiment, the second aqueous solution may not include a supplemental reagent besides the strong acid, such as a redox reagent. For example, the second aqueous solution may not include a reducing agent or an oxidizing agent. As a further example, the second aqueous solution may not include hydrogen peroxide. Conventionally, the second aqueous solution may include supplemental redox reagents to aid in leaching of desired metallic elements into the leachate in the desired oxidation state. However, due to the treatment of the black mass before step 210 as shown in method 200, a desirable yield of metal elements in the desired oxidation states may be transferred to the leachate without demanding additional redox reagents. By not adding supplemental redox reagents, the impurity removal process may be simplified. For example, supplemental redox reagents may introduce additional impurities demanding further downstream remediation. Additionally, excess supplemental redox reagents may undergo unwanted side reactions in downstream impurity removal steps, thereby adding additional time and reagents to subsequent impurity removal steps.

At 211, method 200 includes separating the insoluble material and the leachate solution. As one example separating the insoluble material and the leachate solution includes separating graphite and the leachate solution. Separating may include separating by liquid-solid separation such as filtration. At 212, method 200 includes removing the second group of impurity ions from the leachate. The second group of impurities may include at least one of calcium ions, magnesium ions, iron ions, aluminum ions, iron ions, aluminum ions, copper ions, zinc ions, and fluoride ions. As one example, removing the second group of impurities may include a combination of one or more of precipitation, electro-hydrolysis/deposition, and chromatography. A method of removing the second group of impurities is described further below with respect to FIG. 2B.

At 214, method 200 includes adjusting concentrations of the p-CAM metal ions. Adjusting the concentration of p-CAM metal ions may include adding metal salts or solutions of metal salts to the leachate to obtain a desired ratio of p-CAM metal ions in the leachate. For example, sulfate salts of the desired metals may be dissolved in the leachate solution to bring a ratio of p-CAM metals to a desired ratio. The desired ratio may depend on a desired composition of the p-CAM. For example, a p-CAM having a 8:1:1 ratio of nickel:manganese:cobalt may be desired. Amounts of nickel sulfate, cobalt sulfate, and manganese sulfate may be added to the leachate to adjust nickel, manganese, and cobalt ions to the desired ratios and concentrations.

At 216, method 200 includes synthesizing the p-CAM. Synthesizing the p-CAM may include increasing a pH of the leachate by adding a base such as a hydroxide base until the p-CAM material co-precipitates as hydroxide salts. By adjusting the metal ion ratios and concentrations at step 212, the co-precipitated p-CAM may homogeneously include the p-CAM metals in the desired ratios. Additionally, by removing impurity ions from the DLBM and leachate as described above, the synthesized p-CAM may be of a desired purity for including in new lithium ion battery cathodes. A desired purity level may vary depending on manufacturing specifications for the new lithium ion battery. Method 200 ends.

Turning now to FIG. 2B, an example of method 250 for removing the second group of impurity ions from the recycled LIB stream is shown. Method 250 may be performed on the leachate solution obtained after pre-leaching DLBM as described above with respect to method 200. Additionally, the leachate solution may not include supplemental reduction agents or oxidation agents.

At 252, method 250 includes removing iron, aluminum, and/or copper ions from the leachate solution as precipitates by adding a hydroxide salt to raise a pH of the leachate solution. As one example, the pH may be increased to a range of 3.5 up to 6.2. In some examples, the pH may be increased to a range of 5.4 up to 5.7. Adding a hydroxide salt to raise the pH of the leachate solution may include slowly adding a strong base (e.g., a base which fully dissociates in water) solution to the leachate solution. As one example, the strong base solution may be an aqueous solution including NaOH at a concentration in a range of 10% to 50% by weight. As one example, an equilibrium pH of the leachate solution after adding the hydroxide salt may be in a range of 4.6 to 6.0. As a further example, the equilibrium pH of the leachate solution after adding the hydroxide salt may be in a range of 5.0 to 5.8. In some examples the leachate solution may be held above room temperature while adding the hydroxide salt. For example, the temperature may be in a range of 60° C. to 90° C. In some examples, the temperature may be in a range of 70° C. to 80° C.

In some examples, adding the hydroxide salt may include adding the hydroxide salt to the leachate solution in stages. For example, the leach solution may undergo a first slow pH increase to an equilibrium pH range of 3.0-4.5 and then a second slower pH increase to an equilibrium pH range of 5.4-5.6. As one example, a first amount of a strong base solution may be added to the leachate to increase the equilibrium pH to a first increased level. For example, the pH may be increased to a range of 3.0-4.5 by adding a 25-50% by weight solution of sodium hydroxide to the leachate under an O₂ enriched environment (e.g., bubbling O₂ gas into the leachate). The equilibrium pH of the leachate may be held at 4.5 while stirring in the O₂ enriched environment for a first duration. For example, the first duration may be in a range of 2 hours up to 6 hours. Then a second amount of strong base may be added and stirred for a second duration. For example, the equilibrium pH may be increased slowly to 5.6 by adding a 25% by weight sodium hydroxide solution over a duration of 2 hours up to 12 hours. In some examples, the additional strong base may be added to maintain the equilibrium pH at the desired pH for the first duration and second duration. After raising the equilibrium pH of the leachate solution, impurity ions of the second group including iron ions, aluminum ions, and/or copper ions may precipitate from solution and may be removed from the leachate by solid/liquid separation.

Table 2 below shows percent removal of metal elements of interest from the leachate solution after stepwise pH increases by adding a strong base solution to the leachate. A sample of leachate is removed and subjected to elemental analysis by ICP-OES at each stage to determine a percent loss.

TABLE 2
Percent loss of elements from leachate with addition of concentrated strong base

| | Temp | | % Removal of Element | | | | | | | |
|---|---|---|---|---|---|---|---|---|---|---|
| pH | (° C.) | Fe | Al | Cu | Ni | Mn | Co | Mg | Ca | Zr |
| 4.5 | 80 | 99% | 98% | 34% | 4.1% | −19% | 7.4% | 0% | 26% | 97% |
| 5.6 | 80 | 99% | 100% | 96% | 2.6% | −19% | 5.9% | −1.3% | 29% | 97% |
| 6.3 | 80 | 99% | 100% | 99% | 34% | −0.6% | 36% | 8.1% | 32% | 98% |

As shown in Table 2, increasing equilibrium pH may effectively remove iron, aluminum, and copper ions from the leachate. Magnesium and calcium ions, if present, may also be precipitated by raising the equilibrium pH.

In further examples, increasing the pH of the leachate solution in stages may include adding a first amount of strong base solution to the leachate solution to increase the equilibrium pH to a first increased level. In the example, the first increased pH level may be about 2. In the second stage the hydroxide salt may be a weak base. The weak base (e.g., a base which does not fully dissociate in water) hydroxide salt may be added as a solution or slurry to the leachate solution to raise the equilibrium pH to the desired pH for step 252. As one example, the weak base may be one or more of calcium hydroxide, magnesium hydroxide, or combinations thereof. In alternate embodiments, the weak base may additionally or alternatively be one or more of calcium oxide or calcium carbonate. In such examples, a weak base may be added as a slurry due to the limited aqueous solubility of the weak base. The limited solubility of the weak base may contribute to a slower more homogeneously dispersed rise in the pH of the leachate solution compared to addition of strong base solution. In some examples, step 252 further comprises removing zinc ions and iron ions, aluminum ions, and/or zinc ions may be removed by hydrolysis precipitation with calcium hydroxide or magnesium hydroxide.

Table 3 below shows percent removal of metal elements of interest from the leachate after stepwise pH increases by adding a weak base slurry of calcium hydroxide to the leachate. A sample of leachate solution is removed and subjected to elemental analysis by ICP-OES at each stage to determine a percent loss.

TABLE 3
Percent removal of elements from leachate
with addition of weak base slurry

| | Temp | % Removal of Element | | | | | |
|---|---|---|---|---|---|---|---|
| pH | (° C.) | Fe | Al | Cu | Ni | Co | Mn |
| 4.52 | 70 | 99% | 96% | 35% | −1.0% | −2.0% | −1.8% |
| 5.48 | 70 | 99% | 100% | 98% | 1.7% | 0.0% | −1.0% |
| 6.09 | 70 | 99% | 100% | 98% | 10% | 7.4% | 7.0% |
| 6.15 | 70 | 99% | 100% | 98% | 12% | 8.2% | 8.4% |

As shown in Table 3, raising the equilibrium pH by addition of the weak base slurry may also substantially remove iron ions, aluminum ions and copper ions from the leachate solution. Additionally, a loss of nickel ions from the leachate solution may be less when increasing the pH using the weak base slurry than when using the strong base solution. In some examples, adding the weak base slurry may further introduce impurities such as calcium and/or magnesium ions to the leachate solution. In addition to pre-leaching as described above with respect to FIG. 2A, when calcium and/or magnesium are reintroduced in the weak base slurry, additional steps to remove calcium and magnesium ions from the leachate solution are considered and are described further below.

Alternatively, calcium oxide may be added as the weak base slurry. Table 4 below shows percent removal of elements after addition of calcium oxide slurry to adjust an equilibrium pH of the leachate solution to 6.3. The leachate solution may be stirred for a total of 4 hours to further react the calcium oxide with the impurity ions. Samples are taken before adding the calcium oxide slurry and at each hour. ICP-OES is used to determine percent removal of elements of interest.

TABLE 4
Percent removal of metallic elements from
leachate after CaO slurry addition

| Time | % Removal of Element | | | | | | |
|---|---|---|---|---|---|---|---|
| (hrs) | Ni | Co | Fe | Al | Cu | Zn | Zr |
| 1 | 3% | 5% | 3% | 1% | 2% | 7% | 0% |
| 2 | −10% | −9% | 100% | 96% | 36% | 8% | 100% |
| 3 | 0% | 0% | 100% | 99% | 90% | 20% | 100% |
| 4 | 19% | 16% | 100% | 100% | 98% | 72% | 100% |

As shown in Table 4, CaO as a weak base may also effectively remove iron ions, copper ions, and aluminum ions from the leachate solution. Additionally, CaO slurry may also cause zinc ions and zirconium ions to precipitate from the leachate solution.

At 254, method 250 includes removing additional impurity ions of the second group of impurity ions from the leachate solution. In some examples, the additional ions of the second group of impurities may include at least one of zinc ions, copper ions, and fluoride ions. In further examples, the additional impurity ions of the second group of impurity ions may further include one or more of calcium ions and magnesium ions and ions that may be introduced as a result of previous impurity removal steps.

In some examples, removing the additional impurity ions of the second group of impurity ions may include removing copper ions by precipitation and/or cementation at 256. Removing copper ions by cementation may include adding iron metal powder or nickel metal powder. Adding iron metal powder and/or nickel metal powder may result in reduction of Cu²⁺ to Cu° when in acidic solution, causing metallic copper to precipitate from the leachate solution which may be removed by solid/liquid separation. In examples where copper is removed by cementation, removing copper ions at 256 may occur before removing iron ions, aluminum ions, and/or copper ions as described at step 252. In this way, additional iron impurities introduced during cementation may be precipitated by the hydroxide salt. The desired oxidation may not occur under the weakly acidic conditions present in the leachate solution after step 252 and in examples where iron powder is added, iron ions added to the leachate as a result of adding the iron powder may be subsequently precipitated from solution at step 252. As one example, the iron and/or nickel powder may be added as a slurry with a 1:1.5 molar ratio of copper to iron. In some examples, a pH of the solution may be 3.0 when the iron and/or nickel powder is added. In some examples the leachate solution may be warmed above room temperature when the iron and/or nickel powder is added to leachate. In some examples a slurry including the iron/nickel metal may be added to the leachate solution in multiple steps.

Table 5 below shows percent loss of elements from the leachate solution after cementation by addition of iron powder. Percent loss is determined by measuring elemental concentrations by ICP-OES before and after addition of the iron powder. A pH of the leachate solution may have been increased from the pH value of the leachate solution at step 211 up to a pH 3.0.

TABLE 5
Percent loss of elements from leachate after addition of iron metal

| | |
|---|---|
| Temp | % Loss of Elements |

| pH | (° C.) | Al | Cu | Ni | Co | Mn |
|---|---|---|---|---|---|---|
| 3.0 | 70 | 85% | 99% | 11% | 9.7% | 9.4% |

As demonstrated in Table 5, cementation by addition of iron metal may effectively remove copper from the leachate solution with less than 15% loss of the desired p-CAM metals.

In alternate examples, removing the copper ions at 256 may include removing the copper ions by precipitation by adding a sulfide salt and/or sulfide reagent to the leachate solution. The sulfide reagent and/or salts may include hydrated or anhydrous sodium sulfide (Na₂S) and/or dihydrogen sulfide (H₂S), or other sources of sulfide ions. Sulfide ions may react with copper ions to precipitate copper as insoluble copper sulfide (CuS). The reaction between the sulfide ions and copper ions may occur over a wide pH range. A molar ratio of copper ions to sulfide precipitation reagent may be in a range (Cu:sulfide) of 1:2 up to 1:3. In an exemplary embodiment, addition of the sulfide precipitation reagent may occur at room temperature. After addition of the sulfide precipitation reagent, the leachate solution may be stirred for a duration in a range of 10 minutes up to 2 hours. In some examples, the duration may be in a range of 30 minutes to 1 hour. After the duration, the precipitated copper sulfide may be removed from the leachate solution by solid/liquid separation.

In an exemplary embodiment, the precipitation reagent is a sulfide reagent and adding the precipitation reagent may occur after removing copper ions at step 252. In this way, the copper ions remaining after raising the pH may be subsequently removed from the leachate solution by precipitation as copper sulfide. Use of a minimal amount of sulfide for precipitation may be desired to minimize addition of sulfur impurities and because although unreacted sulfide ions are slowly oxidized to sulfate ions in the solution, possible dihydrogen sulfide in acidic solution may be volatile and noxious. Adding sulfide reagent after a majority of copper impurities have been removed at step 252 may help minimize an amount of demanded sulfide reagent. Additionally, the sulfide reagent may further react with other oxidizing agents if present. An amount of sulfide reagent demanded may be minimized by not including additional redox reagents in forming the leachate solution (e.g., step 210 of FIG. 2A). Furthermore, removing copper impurities with a precipitation reagent such as a sulfide reagent can be used with removal of copper impurities by cementation as described above, in any combination and order, thereby maximizing the copper removal.

Table 6 below shows the copper ions removal efficiency using a solution of sodium sulfide nonahydrate as the precipitation reagent. Copper concentration in the leachate solution is measured before and after the reaction time by ICP-OES to determine a copper removal efficiency (e.g., percent loss of copper).

TABLE 6
Efficiency of copper removal after addition of sodium sulfide

| pH of | | | | |
|---|---|---|---|---|
| leachate | Cu:Na₂S molar ratio | Reaction time | | Cu removal efficiency |
| 5.94 | 1:3 | 1 | hour | 97.71% |
| 5.60 | 1:3 | 1 | hour | 99.05% |
| 5.20 | 1.2 | 1 | hour | 99.09% |
| 5.20 | 1:3 | 30 | min | 99.93% |
| | | 1 | hour | 98.98% |
| 5.60 | 1:2 | 30 | min | 98.81% |
| | | 1 | hour | 98.75% |
| 5.60 | 1:3 | 30 | min | 98.45% |
| | | 1 | hour | 98.82% |
| 5.91 | 1:2 | 30 | min | 98.06% |
| | | 1 | hour | 97.59% |
| 5.91 | 1:3 | 30 | min | 98.43% |
| | | 1 | hour | 98.23% |
| 5.82 | 1:2 | 30 | min | 99.09% |
| | | 1 | hour | 98.60% |
| 5.30 | 1:2 | 1 | hour | 100% |
| 5.52 | 1:2 | 30 | min | 99.72% |
| | | 1 | hour | 100% |
| 5.51 | 1:2.3 | 30 | min | 98.81% |
| | | 1 | hour | 98.04% |
| 5.51 | 1:2.3 | 30 | min | 98.38% |
| | | 1 | hour | 98.18% |
| 5.51 | 1:2.5 | 30 | min | 99.28% |
| | | 1 | hour | 98.42% |

As shown in Table 6, addition of sodium sulfide may, in some examples, remove 100% of copper ions from the leachate solution. In all examples, at least 98% of copper impurity ions are removed.

Optionally, at 258, method 250 may include removing copper ions, zinc ions and/or magnesium ions by selective electro-hydrolysis/electrolysis. Herein, electro-hydrolysis refers to hydrolysis of metal salts caused by electrolysis. Selective electro-hydrolysis/electrolysis may include applying current to the leachate solution while circulating the leachate solution through an electrolysis chamber. The electrolysis chamber may include two electrode plates acting as the anode and cathode respectively and an electric potential may be applied between the two. As one example, the potential may be 5V and the current may be 3 A. Additionally, the potential may be adjusted while maintaining the current to account for a decrease in the impurity ion concentrations. Electro-hydrolysis/electrolysis may occur for a duration of up to 12 hours. Applying electric potential may drive redox reactions in the leachate solution causing impurity metals to plate onto one of the electrodes.

In some examples, electro-hydrolysis/electrolysis may occur before removing iron ions, aluminum ions, calcium ions and/or copper ions at step 252. For example, a pH of the leachate may be adjusted to a range of 2-3 before applying current, and additional acid or base solutions may be added while applying current to maintain the pH in the desired range. In some examples, applying the current may locally deplete protons at a surface of the cathode, forming an electric double layer. The electric double layer may attract cations such as Mg²⁺ which may deposit on the cathode as Mg(OH)₂.

Table 7 below shows an example of percent metal removal from the leachate solution when applying 5V at a current of 3 A to a circulated leachate solution. The leachate solution is derived from DLBM (e.g., after step 210 of FIG. 2A). A pH of the leachate solution may be adjusted in a range of 2-3 and maintained in the range while current is applied. Concentrations of elements are measured by ICP-OES before application of the current and of samples taken over time while current is being applied.

TABLE 7
Percent loss of elements by applying current to leachate solution

| | |
|---|---|
| Time | % Loss of Element |

| (hrs) | Ca | Mg | Ni | Mn | Co | Cu |
|---|---|---|---|---|---|---|
| 4 | 23% | 45% | 22% | 14% | 19% | 93% |
| 8 | 17% | 44% | 19% | 27% | 19% | 81% |
| 12 | 10% | 37% | 8% | 40% | 9% | 77% |

As shown in Table 7, applying current may remove calcium, magnesium and copper impurities from the leachate. In some examples, impurities may be preferentially removed at shorter electrolysis times while p-CAM metal ions may be maintained at higher concentrations in the leachate at longer electrolysis times. An electrolysis time may be balanced between removing a desired amount of impurities while leaving a maximum concentration of p-CAM metal ions in the leachate solution.

As a further example, a pH of the leachate solution may be adjusted and maintained at 4 during electrolysis. Results of percent metal removal from a leachate solution adjusted to pH 4 before applying current are shown in Table 8 below. Concentrations of elements in aliquots removed before applying current and at the indicated time points are determined by ICP-OES and used to determine percent loss of elements.

TABLE 8
Percent removal of elements from pH 4 leachate solution

| Time | % Loss of Elements | | | | | | | | |
|---|---|---|---|---|---|---|---|---|---|
| (hrs) | Ni | Co | Cu | Al | Mg | Zn | Zr | Si | Ti |
| 2 | 5% | 13% | 5% | 26% | 0% | 51% | 36% | 10% | 0% |
| 4 | 2% | 14% | 86% | 98% | 15% | 69% | 67% | 22% | 31% |
| 6 | −2% | 16% | 98% | 99% | 8% | 79% | 71% | 30% | 62% |
| 8 | −7% | 17% | 96% | 100% | 2% | 82% | 82% | 36% | 57% |
| 10 | −4% | 17% | 99% | 100% | n/a | 74% | 85% | 48% | 76% |

As shown in Table 8, electrolysis at pH 4 may effectively remove copper ions, aluminum ions, and zinc ions from the leachate solution without removing a desired amount of p-CAM metal ions from the leachate solution. As a further example, electrolysis may additionally remove zirconium ions, silicon ions, and titanium ions from the leachate solution.

In alternate examples, applying current to the leachate solution may occur after increasing the pH of to the first level at step 258. For example, a pH of the leachate solution when the current is applied may be in a range of 5-6. An example of percent removal of metal ions from a leachate solution after raising the pH to 5.6 and then after applying a current (e.g., 5V at 3 A) is shown table 9 below. Concentrations of metal ions in the leachate solution are measured by ICP-OES before hydrolysis, after base hydrolysis (e.g., after adding the hydroxide salt to raise pH), and after applying current to determine percent loss of elements after reach step.

TABLE 9
percent loss of elements from leachate solution
after base hydrolysis and electrolysis

| | % Loss of Element | | | | | | |
|---|---|---|---|---|---|---|---|
| Step | Cu | Ni | Mn | Co | Al | Fe | Zn |
| Post base | 96% | 3% | 4% | 2% | 100% | 100% | 53% |
| hydrolysis | | | | | | | |
| Post applied | 99% | −2% | −3% | −2% | 99% | 100% | 93% |
| current | | | | | | | |

As shown in Table 9, applying current after increasing pH may effectively further remove copper ions and zinc ions from the leachate solution without further decreasing concentrations of the p-CAM metals.

At 260, method 200 optionally includes removing fluoride ions, magnesium ions, calcium ions, copper ions, and/or zinc ions from the leachate solution by chromatography. Chromatography may include contacting the leachate solution with a solid phase adsorbent or chromatography resin. As one example, the adsorbent may be activated alumina. As a further example, the chromatography resin may be an ion exchange resin, reverse phase resin, gel chromatography resin, or the like. In some examples, removing ions by adsorbent or chromatography may occur when the leachate solution is acidic. Contacting the leachate solution with adsorbent or chromatography resin may occur before or after adjusting the pH at step 252. Magnesium ions, calcium ions, zinc ions, fluorine ions, and copper ions may be removed from the leachate solution by contact with adsorbent or chromatography resin.

As one example, chromatography resins may be used to remove magnesium ions and calcium ions from metal leachate after adding an amount of hydroxide salt to raise the pH at 252. In an exemplary embodiment, ion exchange resins may be used. Chromatography resins may be used to remove remaining magnesium and calcium present after pre-leaching and/or remove magnesium or calcium added due to a calcium or magnesium salt being used as the hydroxide salt at step 252. Table 10 below shows percent removal of elements from the leachate solution after passing through a series of columns of ion exchange resins. The leachate solution was first adjusted to 5.6 by addition of a hydroxide salt and hydroxide precipitates were separated from the leachate solution. A pH of the leachate solution is then adjusted to 4 before passing through the ion exchange resin columns. Eluate of the columns is analyzed by ICP-OES to calculate percent loss of the elements.

TABLE 10
Percent loss of elements after passing through ion exchange resin

| | % Loss of Element | | | | | | | |
|---|---|---|---|---|---|---|---|---|
| Column | Mg | Ca | Zn | Cu | Al | Ni | Co | Mn |
| 1^{st} | 16% | 66% | 100% | 25% | 100% | 18% | 18% | 33% |
| 2^{nd} | 18% | 93% | 100% | 35% | 109% | 24% | 24% | 51% |
| 3^{rd} | 17% | 97% | 100% | 43% | 109% | 25% | 25% | 59% |

As shown in Table 10, the ion exchange resin may remove calcium ions and magnesium ions as well as zinc ions from the leachate solution at pH 4. Residual aluminum ions and copper ions may also be at least partially removed from the leachate. Some removal of p-CAM metal ions may also occur, especially after the third column, however less p-CAM metal ions may be removed than impurity ions.

As a further example, the leachate solution may be contacted with activated alumina. In an exemplary embodiment the leachate solution may be passed through a column filled with the activated alumina. Activated alumina may be particularly useful for removing fluoride impurities from the leachate solution without removing p-CAM metal ions. In an exemplary embodiment metal leachate may be passed through a column of activated alumina. As one example, the column processes (e.g., chromatography) are not sequential separation processes by interaction between mobile phase and stationary phase, but based on specific adsorption capabilities of the resins or adsorbent materials at a given equilibrium pH. FIG. 4 shows a graph 400 of fluoride concentration as a function of eluate volume in bed volume equivalents. As shown in FIG. 4, even at one bed volume, a majority of fluoride ions may be removed from the solution.

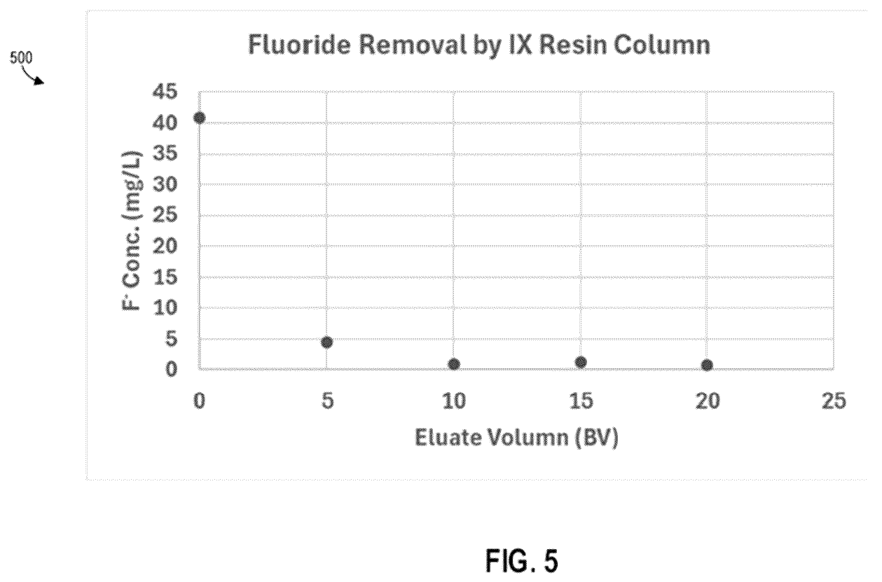

In an alternate example the leachate solution may be contacted with an ion exchange resin. In an exemplary embodiment, the leachate solution may be passed through a column filled with the ion exchange resin. FIG. 5 shows a graph 500 of fluoride concentration as function of eluate volume in bed volume equivalents. In the example of FIG. 5, the pH of the leachate solution was adjusted to 4.5 before introducing leachate solution to the column of ion exchange resin. As shown in FIG. 5, the fluoride impurity may be substantially removed from the leachate solution.

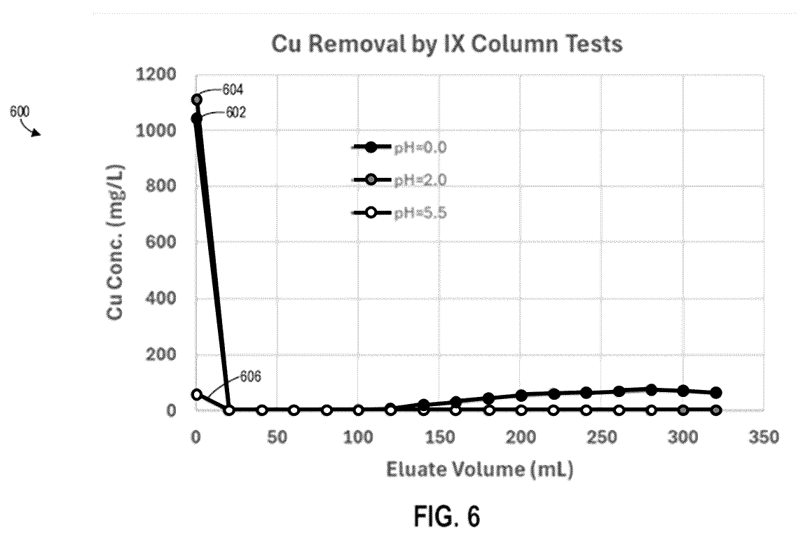

Additionally, contacting the leachate solution with chromatography resin may also remove copper impurity ions from the leachate solution. In one example, a pH of the leachate solution may be adjusted to a range of 0.0 up to 5.5. FIG. 6 shows a graph 600 of copper concentration of leachate solution eluted from an ion exchange column as a function of eluate volume. In the example of FIG. 6, the metal leachate was adjusted to a pH of 2.0 before eluting onto the ion exchange resin column. A first plot 602 shows the copper concentration as a function eluate volume for a pH 0.0 metal leachate feed solution. A second plot 604 shows an example the copper concentration as a function of eluate volume for a pH 2.0 metal leachate feed solution. A third plot 606 shows an example of the copper concentration as function of pH for a pH 5.5 metal leachate feed solution. Each pH may be effective in removing copper ion impurities from the leachate solution. In the example where the pH of eluate is 5.5, copper may additionally be precipitated from solution before being isolated by the ion exchange resin. For this reason, a starting concentration for plot 606 is lower than for plots 602 and 604.

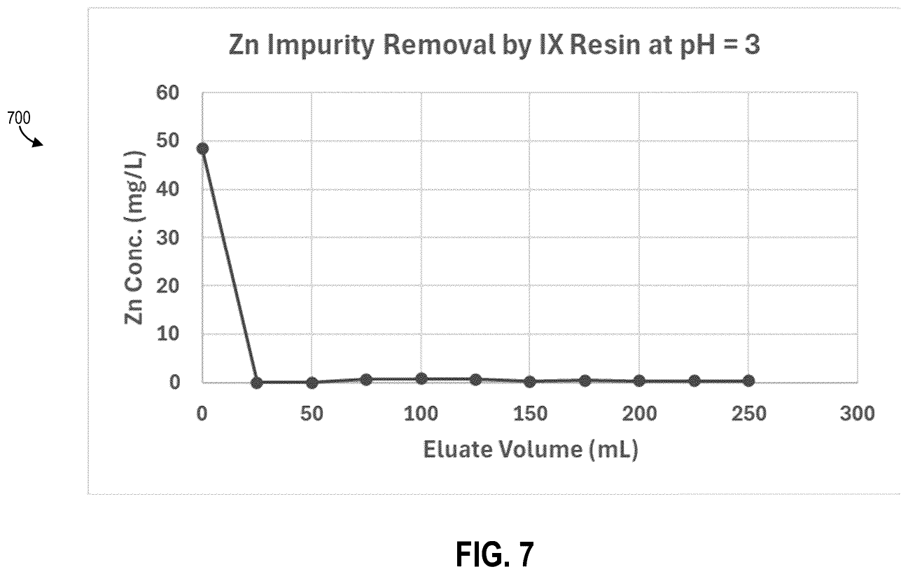

Additionally or alternatively, contacting the leachate solution with chromatography resin may also remove zinc impurity ions from the leachate solution. FIG. 7 shows a graph 700 of zinc concentration as a function of eluate volume when eluting a leachate solution through a column of ion exchange resin. In the example of FIG. 7, before eluting a pH adjusted metal leachate through the column, the column is rinsed with the same pH aqueous acidic solution as the pH adjusted metal leachate to precondition the resin.

As described above, pre-leaching may be combined with precipitation and one or more additional methods of impurity removal to separate different subsets of impurity ions from the p-CAM metals. Turning now to FIG. 3, it schematically shows materials in a spent lithium-ion battery recycling stream from a black mass stage to a leachate solution through a series of impurity management steps to reach a leachate solution including substantially the p-CAM metals; manganese, nickel, and cobalt and not including other unwanted impurities. In diagram 300, boxes outlined with solid lines indicate solid phases while boxes outlined with dotted lines indicate liquid phases. Diagram 300 shows one possible combination of steps of the methods described above with respect to FIGS. 2A and 2B. It is understood that other combinations are also considered in the scope of the disclosure.

Box 302 may correspond to black mass derived from the shredded spent lithium batteries as described above with respect to step 202 of FIG. 2A. The black mass may include p-CAM metals cobalt, manganese, and nickel as well as lithium and may also include aluminum, copper, magnesium, calcium, zinc, and fluoride impurities. The black mass may undergo lithium extraction as described above with respect to steps 204 and 206 of FIG. 2A to obtain the delithiated black mass shown in box 304. The delithiated black mass may include all the elements of the black mass except for lithium which may be leached away in the liquid phase. The delithiated black mass may then be pre-leached to obtain the pre-leached delithiated black mass indicated in box 306. Pre-leaching may remove magnesium and calcium (e.g., first group of impurity ions) from the solid phase delithiated black mass into the liquid phase.

The delithiated and pre-leached black mass of box 306 may then be leached as described above with respect to step 210 of FIG. 2A. Leaching may bring all of the desired p-CAM metals from the solid phase of the delithiated black mass into the leachate liquid phase along with the remaining impurity ions (e.g., second group of impurity ions). The composition of the leachate is indicated by box 308. A pH of the leachate solution may then be increased to precipitate a subgroup of impurities from the leachate, leaving behind metals shown in the leachate at box 310. In the example, base precipitation may remove iron ions and aluminum ions from the leachate as a solid precipitate. Additionally, the reagent used in the base precipitation may not introduce additional metal impurities such as magnesium or calcium to the leachate. The leachate of box 310 may then be eluted through a column including either activated alumina or ion exchange resin to obtain a leachate indicated by box 312 from which fluoride ions have been removed. A sulfide precipitation reagent may then be added to the leachate to remove the copper impurities as solid copper sulfate to obtain the leachate indicated by box 314. The leachate may then be eluted through a second column including an ion exchange resin. The ion exchange resin may selectively remove any remaining zinc from the leachate solution to obtain the leachate indicated by box 316. The leachate of box 316 may include the p-CAM metal ions and may not include unwanted impurities. The leachate of box 316 may then be used following the steps discussed above with respect to FIG. 2A to adjust a metal concentration and precipitate the p-CAM.

The technical effect of methods 200 and 250 is to separate impurity ions from p-CAM metal ions in a process where the entire battery is shredded to produce the granular black mass. The separation steps may use chemical and/or physical processes to selectively partition ions between a solid phase and a liquid phase. In this way, the p-CAM metal ions may be isolated for use in new lithium ion batteries without adding multiple costly and time consuming steps to separate cathode active materials from the rest of the battery component when producing the granular black mass.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for removing impurities from recycled battery black mass, comprising:
mixing a delithiated black mass and a first aqueous solution to form a pre-leached delithiated black mass and a pre-leach solution, the pre-leach solution comprising a first group of impurity ions from the delithiated black mass;
separating the pre-leached delithiated black mass and the pre-leach solution;
mixing the separated pre-leached delithiated black mass and a second aqueous solution to form a mixture comprising graphite and a leachate solution, the leachate solution comprising cathode precursor metal ions and a second group of impurity ions from the pre-leached delithiated black mass; and
separating the graphite and the leachate solution.

2. The method of claim 1, wherein the delithiated black mass is formed by extracting lithium ions from granular black mass obtained from a lithium-ion battery recycling stream.

3. The method of claim 2, wherein the granular black mass is heat treated prior to extracting the lithium ions.

4. The method of claim 1, wherein a pH of the first aqueous solution is greater than a pH of the second aqueous solution.

5. The method of claim 4, wherein the pH of the first aqueous solution is between 2.0 and 7.0, and further comprising actively maintaining the pH of the first aqueous solution while mixing.

6. The method of claim 4, wherein the second aqueous solution comprises strong acid in a concentration range of 1M up to 7M.

7. The method of claim 1, wherein the second aqueous solution is not comprised of a reducing or oxidizing agent.

8. The method of claim 1, wherein the delithiated black mass and the first aqueous solution are mixed at a temperature between 20° C. and 90° C.

9. The method of claim 1, wherein a duration of mixing the delithiated black mass and the first aqueous solution is in a range of 2 hours to 24 hours.

10. The method of claim 1, wherein mixing the delithiated black mass and the first aqueous solution comprises mixing the delithiated black mass with water and then adding an acid to a slurry of delithiated black mass and water.

11. The method of claim 1, wherein the first group of impurity ions of the pre-leach solution includes at least one of magnesium ions and calcium ions.

12. The method of claim 11, further comprising removing magnesium ions and calcium ions from the pre-leach solution.

13. The method of claim 12, wherein magnesium ions and calcium ions are removed by electro-hydrolysis/deposition, precipitation, or chromatography.

14. The method of claim 1, wherein the second group of impurity ions of the leachate solution comprises at least one of calcium ions, magnesium ions, iron ions, aluminum ions, copper ions, zinc ions, and fluoride ions.

15. The method of claim 14, further comprising removing iron ions, aluminum ions, or copper ions from the leachate solution by increasing a pH of the leachate solution with a hydroxide salt to precipitate the second group of impurity ions.

16. The method of claim 14, further comprising removing iron ions, aluminum ions or zinc ions by hydrolysis precipitation with calcium hydroxide or magnesium hydroxide.

17. The method of claim 14, further comprising removing fluoride ions with activated alumina or an ion exchange resin.

18. The method of claim 14, further comprising removing fluoride ions, copper ions, or zinc ions by chromatography.

19. The method of claim 14, further comprising removing copper ions by electrolysis or cementation.

20. The method of claim 14, further comprising removing zinc ions, copper ions, or magnesium ions by selective electro-hydrolysis.

21. The method of claim 14, further comprising removing copper ions by precipitation with a precipitation reagent.

22. The method of claim 21, wherein the precipitation reagent is a sulfide salt.

23. The method of claim 21, wherein a molar ratio of copper ions to the precipitation reagent is in a range of 1:2 to 1:3.

24. The method of claim 1, wherein the pre-leach solution comprises less than 10% of nickel ions from the delithiated black mass.

25. The method of claim 1, wherein the cathode precursor metal ions are comprised of nickel, manganese, and cobalt.
